(19) United States
(12) Patent Application Publication
(10) Pub. No.: US 2024/0308172 A1
(43) Pub. Date: Sep. 19, 2024

(54) THERMALLY PROTECTIVE COMPOSITE MATERIAL

(71) Applicant: Bemis Associates, Inc., Shirley, MA (US)

(72) Inventors: Henry Gilbert, Portland, OR (US); Daniel Calabrese, Portland, OR (US); Alice Clemans, Portland, OR (US)

(21) Appl. No.: 18/587,488

(22) Filed: Feb. 26, 2024

Related U.S. Application Data
(60) Provisional application No. 63/452,243, filed on Mar. 15, 2023.

(51) Int. Cl. B32B 3/30; A41D 1/00; A41D 27/28; A41D 31/06; B32B 5/02; B32B 5/26; B32B 7/14; B32B 37/12; B32B 37/18; B32B 38/00

(52) U.S. Cl. CPC B32B 3/30; A41D 1/00; A41D 27/285; A41D 31/065; B32B 5/026; B32B 5/26; B32B 7/14; B32B 37/1292; B32B 37/18; B32B 38/1875; A41D 2300/322; A41D 2400/10; A41D 2400/38; A41D 2500/00; B32B 2250/03; B32B 2305/182; B32B 2307/304; B32B 2307/51; B32B 2307/724; B32B 2307/7265; B32B 2437/00

(57) ABSTRACT

A thermally protective composite material is provided, which can be used in making garments. The thermally protective composite material includes an outer layer of fabric/textile, an adhesive layer applied to the outer layer of fabric in a geometric pattern, and an elastic inner layer of fabric/textile, adhered in a stretched state, to the outer layer via the adhesive layer. The elastic inner layer, when in a relaxed state, causes the adhered outer layer to vault/bubble forming raised cavities according to the geometric pattern of the adhesive. When constructed into garments the thermally protective composite material can stretch between the relaxed state and the stretched state of the elastic inner layer.

### CROSS-REFERENCE TO RELATED APPLICATION(S)

This application claims priority to, and the benefit of, co-pending U.S. Provisional Application No. 63/452,243 filed Mar. 15, 2023, for all subject matter common to both applications. The disclosure of said provisional application is hereby incorporated by reference in its entirety.

### FIELD OF THE INVENTION

The present invention relates to a thermally protective composite material suitable for garments and/or other outdoor gear. In particular, the present invention relates to a thermally protective composite material that uses tension between two adhered layers of fabric/textile to create a pattern of vaulted cavities that trap air and also, when the material is used to make garments, enables the garments to stretch as the wearer moves, while providing insulation without the use of fill materials such as polyfill or down, and also without requiring air-tight inflatable channels or pockets.

### BACKGROUND

Generally, outdoor or cold-weather activities can present unique issues for garments. For example, ski mountaineering is an intense sport that features rigorous high-output aerobic activity in high-elevation snowy environments. In such environments, the weather can change rapidly and with little warning. The combination of high elevation, steep canyons that manipulate the wind direction, and frequent snow cause the weather in mountainous regions to change faster and be less predictable than the weather at lower elevations.

However, while the outdoor weather can change rapidly, the microclimate of the athlete's body can change even more rapidly. As an athlete changes from high-aerobic-output to low-aerobic-output activity in cold areas, the body temperature can drop rapidly, especially if the athlete is sweaty. The combination of high and low-output periods during ski mountaineering leads to two general rules: Staying dry during periods of high activity and staying warm during periods of low activity. Therefore, the best solution to thermoregulation for ski mountaineering will facilitate air flow during high-output uphill travel to keep the user dry and can trap air for insulation to keep the user warm during periods of inactivity and in cold temperatures.

To provide the functionality necessary for such garments, the garments require insulation and water and/or wind resistance. The insulation is typically designed to trap or create air gaps. Air is an incredible insulator, and the trapping of air against the body is the foundation of all insulated garments. An example of this is the “puffy jacket” that has a series of chambers filled with down or another fiber-fill insulator. The water and/or wind resistance is typically provided by using a tightly woven or chemically treated outer layer on the garment.

However, such conventional cold-weather garments can have significant disadvantages as the very weatherproof nature of the garments can make them heavy, not breathable, and/or difficult to move in. For example, the “puffy jacket” has multiple insulation-filled chambers that are lined with a down-proof textile to prevent the down from coming out of the garments over time. Down-proof fabrics are typically made of tightly woven and calendared nylon fabric that often has a DWR finish. This fabric typically has zero stretch or limited stretch, which can limit the mobility of the athlete. Furthermore, such fabrics typically have little moisture-wicking properties and lack breathability. Another type of insulation, fleece, may be used to reduce the bulk of the garment and improve moisture wicking but typically has a lower warmth/weight ratio than down and still requires an outer layer to provide the weatherproofing. In most cases, to provide the desired weatherproofing, the outer layer material has to be tightly woven and/or chemically treated and have increased durability and wear-resistance. Providing such functionality typically means the material has low breathability, which inhibits release of sweat, and has very little stretch, which limits mobility.

### SUMMARY

There is a need for materials that can provide insulation, wind resistance, and water resistance required by, e.g., winter sports athletes, while also improving breathability, mobility, and reducing weight compared to prior existing insulation methods. The present invention is directed toward further solutions to address this need, in addition to having other desirable characteristics.

In accordance with embodiments of the present invention, an insulating composite material solution is provided. The composite material includes an outer layer, an adhesive layer, and an elastic inner layer. The outer layer comprises a fabric/textile that provides some environmental protection such as wind blocking or water protection for the wearer. The adhesive layer is applied in between the fabric/textile layers in a geometric pattern. The elastic inner layer is a fabric/textile, adhered in a stretched state, to the outer layer via the adhesive layer. The elastic inner layer, when in a relaxed state, causes the adhered outer layer to vault/bubble-up to form a raised cavity according to factors including shape, size, and spacing between these cavities, and are determined by the geometric pattern of the adhesive. A garment incorporating the insulating system can stretch between the relaxed state of the inner layer and the stretched state of the inner layers that is adhered to the outer layer via the adhesive layer.

In accordance with aspects of the present invention, the outer layer of fabric/textile comprises a water-repellent, vapor-permeable fabric/textile.

In accordance with aspects of the present invention, the geometric pattern comprises one or more of circles, triangles, quadrilaterals, polygons, curvilinear shapes, or shapes containing both straight and curved lines.

In accordance with aspects of the present invention, the geometric pattern is laser cut or masked from a sheet of adhesive. In other aspects, the adhesive is extruded into a geometric pattern. In some embodiments, the adhesive layer comprises a pattern of geometric shapes where each individual shape is composed of smaller adhesive dots or other small shapes.

In accordance with aspects of the present invention, the elastic inner layer of fabric/textile comprises a moisture-wicking stretch fabric/textile.

In accordance with aspects of the present invention, the stretched state of the elastic inner layer of fabric/textile is stretched in two dimensions. In other aspects, the elastic inner layer of fabric/textile is stretched in four dimensions.

In accordance with embodiments of the present invention, a garment having active insulation is provided. The garment includes an outer layer, an adhesive layer, and an elastic inner layer. The outer layer comprises a fabric/textile that provides some environmental protection such as wind blocking or water protection for the wearer. The adhesive is a layer applied in a geometric pattern. The elastic inner layer is a fabric/textile, adhered in a stretched state, to the outer layer via the adhesive layer. The elastic inner layer, when in a relaxed state, causes the adhered outer layer to vault/bubble forming a raised cavity according to the geometric pattern of the adhesive. The garment is configured as form-fitting to a wearer of the garment when the inner layer is in the relaxed state and the garment expands in portions to the stretched state of the inner layers adhered to the outer layer via the adhesive layer to accommodate force applied by the wearer as the wearer moves.

In accordance with aspects of the present invention, the outer layer of fabric/textile comprises a water-repellent, vapor-permeable fabric/textile.

In accordance with aspects of the present invention, the garment further comprises vents. In some such aspects, the vents comprise zippers.

In accordance with aspects of the present invention, the geometric pattern comprises one or more of circles, triangles, quadrilaterals, polygons, curvilinear shapes, shapes containing both straight and curved lines.

In accordance with aspects of the present invention, the geometric pattern is laser cut from a sheet of adhesive.

In accordance with aspects of the present invention, the adhesive layer comprises adhesive dots or other smaller shapes arranged in a geometric pattern.

In accordance with aspects of the present invention, the elastic inner layer of fabric/textile comprises a moisture-wicking stretch fabric/textile.

In accordance with aspects of the present invention, the stretched state of the elastic inner layer of fabric/textile is stretched in two dimensions. In other aspects, the elastic inner layer of fabric/textile is stretched in four dimensions.

In accordance with embodiments of the present invention, an active insulating system for a garment is provided. The system includes an outer layer, an adhesive layer, and an elastic inner layer. The outer layer comprises a fabric/textile that provides some wind or other environmental protection for the wearer. The adhesive layer is applied inbetween the two fabric/textile layers in a geometric pattern. The elastic inner layer is a fabric/textile, adhered in a stretched state, to the outer layer via the adhesive layer. The elastic inner layer, when in a relaxed state, causes the adhered outer layer to vault/bubble-up to form a raised cavity. A garment incorporating the insulating system can stretch between the relaxed state of the inner layer and the stretched state of the inner layers that are adhered to the outer layer via the adhesive layer thereby reducing hindrances to wearer mobility.

In accordance with embodiments of the present invention, a method of manufacturing an insulating composite material is provided, the method involves providing an outer layer of fabric/textile; applying an adhesive layer to the outer layer of fabric in a geometric pattern; providing an elastic inner layer of fabric/textile; applying tension to the elastic inner layer of fabric/textile to stretch the elastic inner layer to a stretched state; adhering the elastic inner layer of fabric/textile in the stretched state to the outer layer via the adhesive layer; and releasing tension used to stretch the elastic inner layer in stretched state, wherein the elastic inner layer, when in a relaxed state, causes the adhered outer layer to vault/bubble forming raised cavities according to the geometric pattern of the adhesive layer.

In accordance with embodiments of the present invention, a method of manufacturing an insulating composite material is provided, the method involves providing an elastic inner layer of fabric/textile; applying tension to the elastic inner layer of fabric/textile to stretch the elastic inner layer to a stretched state; applying an adhesive layer in a geometric pattern to the elastic inner layer of fabric in the stretched state; providing an outer layer of fabric/textile; adhering the outer layer of fabric/textile to the elastic inner layer of fabric/textile in the stretched state via the adhesive layer; and releasing tension used to stretch the elastic inner layer in stretched state, wherein the elastic inner layer, when in a relaxed state, causes the adhered outer layer to vault/bubble forming raised cavities according to the geometric pattern of the adhesive layer.

This invention has another advantage over other types of insulations: stretch. Many insulated garments on the market use down-filled baffles. This means that the textile used for the garment must be down-proof to prevent the down from coming out of the garments over time. Down-proof fabrics are typically made of tightly woven nylon fabric that often has a DWR finish. This fabric typically has zero stretch or limited stretch, which can limit the mobility of the athlete. Another type of insulation, fleece, can be manufactured with stretch. However, while fleece insulation is not typically windproof or waterproof, the invention described here can use any number of face fabrics, providing wind or water protection as needed.

The present invention differs from other types of insulation in that instead of trapping air in closed pockets like traditional baffles found in a puffy jacket, the raised cavities of the active insulation detailed here are open on one side. This means that the athlete can easily cool themselves if they become too warm by simply opening zippered vents in the garment, allowing the warm air trapped against the body to be flushed out and replaced by cool air from the external environment. The ventilation provided by the insulation described in this invention makes this invention more adaptable to changing environmental conditions than other insulated garments on the market today.

Another advantage of this invention is its wicking nature. As mentioned earlier, puffy garments typically use a down-proof fabric that is tightly woven and often has a DWR finish on it. This fabric does not wick sweat from the user's body and can cause sweat to build up. This buildup of sweat can be problematic for the user. The present invention makes use of a stretch material as an inside layer. This material can be selected to be wicking to help sweat escape.

### BRIEF DESCRIPTION OF THE FIGURES

These and other characteristics of the present invention will be more fully understood by reference to the following detailed description in conjunction with the attached drawings, in which:

FIG. 1 shows a cross-sectional view showing the layers of an active insulation system in accordance with one embodiment of the present invention;

FIG. 2 shows a perspective view of an outer layer of an active insulation system in accordance with one embodiment of the present invention

FIG. 3 shows a perspective view of an adhesive layer in a geometric pattern applied to an outer layer of an active insulation system in accordance with one embodiment of the present invention;

FIG. 4 shows a perspective view of an elastic inner layer in a relaxed state that is stretched to match the dimensions of the outer and adhesive layer in accordance with one embodiment of the present invention;

FIG. 5 shows a perspective view of an elastic inner layer in a stretched state applied to the adhesive layer in accordance with one embodiment of the present invention;

FIGS. 6A-6B shows various cut-away views of vaulting/bubbling of the outer layer forming raised cavities that occurs when the elastic inner layer returns to a relaxed state after being applied to the adhesive layer in accordance with one embodiment of the present invention;

FIG. 7 shows a perspective view of vaulting/bubbling of the outer layer forming raised cavities that occurs when elastic inner layer returns to a relaxed state after being applied to the adhesive layer in accordance with one embodiment of the present invention;

FIG. 8 shows a perspective view of an elastic inner layer of an active insulation system in a relaxed state in accordance with one embodiment of the present invention;

FIG. 9 shows a perspective view of an elastic inner layer of an active insulation system in a stretched state in accordance with one embodiment of the present invention;

FIG. 10 shows a perspective view of an adhesive layer in a geometric pattern applied to an elastic inner layer of an active insulation system in accordance with one embodiment of the present invention;

FIG. 11 shows a perspective view of an outer layer of an active insulation system applied to the adhesive layer in accordance with one embodiment of the present invention;

FIG. 12 shows vaulting/bubbling of the outer layer forming raised cavities that occurs when the elastic inner layer returns to a relaxed state after being applied to the adhesive layer in accordance with one embodiment of the present invention;

FIG. 13 shows a perspective view of a formed active insulation system in accordance with one embodiment of the present invention;

FIG. 14 shows an exploded perspective view of the active insulation system showing the various layers in accordance with one embodiment of the present invention;

FIG. 15 shows another example of the vaulting/bubbling of the outer layer forming raised cavities when elastic inner layer returns to a relaxed state after being applied to the adhesive layer in accordance with one embodiment of the present invention;

FIGS. 16A, 16B, 16C, 16D, 16E, 16F, 16G shows various geometric patterns that are possible for the adhesive layer in accordance with one embodiment of the present invention;

FIGS. 17A-17B shows a jacket using an active insulation system in accordance with one embodiment of the present invention; and

FIGS. 18A-18B shows pants using an active insulation system in accordance with one embodiment of the present invention.

### DETAILED DESCRIPTION

An illustrative embodiment of the present invention relates to an active insulation system for outdoor clothing involving a composite material that allows a garment to stretch as the wearer moves. A garment using the active insulation can be configured as form-fitting to a wearer yet can also expand to accommodate and not restrict the wearer as they move while still providing the insulation, temperature regulation, and weatherproof characteristics necessary for outdoor clothing.

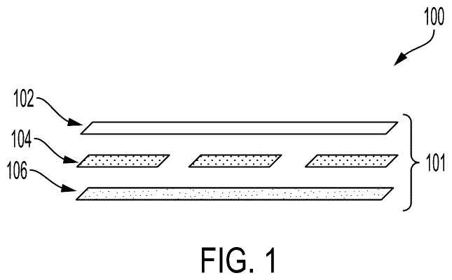

FIG. 1 through FIG. 18, wherein like parts are designated by like reference numerals throughout, illustrate an example embodiment or embodiments of active insulation for garments, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

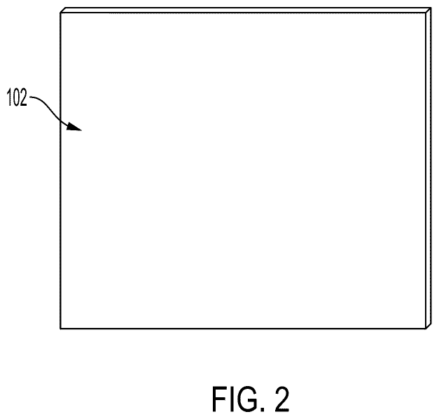

As shown in FIG. 1, The active insulation system 100 of the present invention comprises a composite material 101 having three layers: an outer layer 102, an adhesive layer 104, and an inner layer 106. The outer layer comprises a fabric or textile typically used for an outer layer or “shell” type garment that has low to no ability to elastically stretch. The adhesive layer 104 is in-between and adheres together with the outer layer 102 and the inner layer 106. The inner layer comprises an elastic fabric or textile with high stretch and recovery. The process for assembling the layers and creating the active insulation system 100 is depicted in FIGS. 2-15.

In FIG. 2 the outer layer 102 is provided in preparation for applying the adhesive layer 104. A sheet of the fabric/textile of the outer layer 102 is laid out on a heat press or other surface or apparatus used in adhering fabrics or textiles together. In some embodiments, the outer layer 102 is a fabric or textile comprising a water-repellent, vapor-permeable fabric or textile such Gore-Tex™ by W.L. Gore & Associates, Inc. or other such 2L waterproof fabrics that are highly breathable. It should be understood that other fabrics or textiles, which need not be waterproof, can also be used.

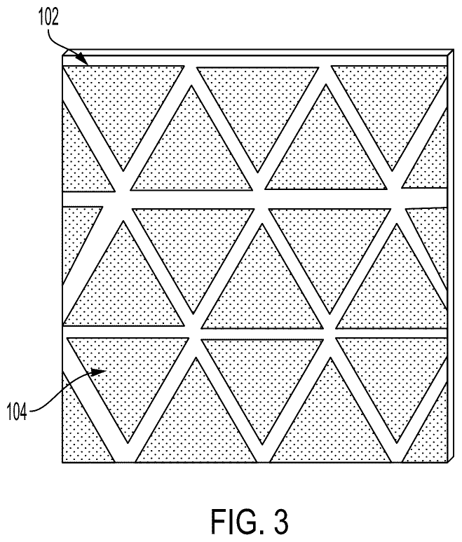

In FIG. 3 The adhesive layer 104 is applied to the outer layer 102 in a geometric pattern. The adhesive of the adhesive layer 104 is an adhesive for bonding fabrics/textiles such as Sewfree™ adhesive (by Bemis Asscoiates, Inc.). In some such embodiments, the geometric pattern is laser cut from a sheet of adhesive material. In other embodiments, the pattern can be mechanically or chemically made from a sheet of adhesive material. In some other embodiments, the adhesive can be extruded in a geometric pattern. In still other embodiments, the adhesive can be applied in strips, dots, or other smaller shapes in a geometric pattern to form the adhesive layer 104.

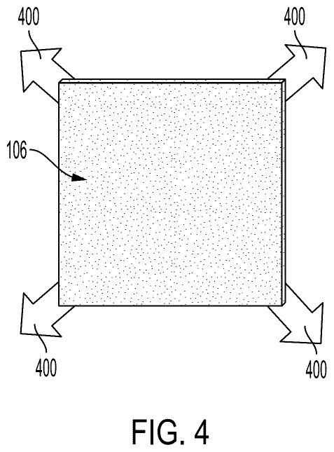

In FIG. 4 the elastic inner layer 106 is provided. Here a sheet of fabric or textile having high stretch and recovery properties, which in a relaxed state is smaller than the sheet of fabric or textile forming the outer layer 102, is stretched to substantially match the dimensions of the sheet of fabric or textile forming the outer layer 102 by applying tension in the directions indicated by arrows 400. The sheet of fabric or textile of the elastic inner layer 102 can be stretched in two (2), four (4), or more directions to conform with the shape and/or dimensions of the outer layer 102 and the adhesive layer 104. In certain embodiments, the elastic inner layer 106 is formed of a 4-way stretch power mesh or similar material. In some such embodiments, the elastic inner layer is a 4-way stretch knit fabric having at least 75% stretch in all directions. In certain embodiments, the stretch fabric or textile of the inner layer 106 also features moisture-wicking characteristics or properties.

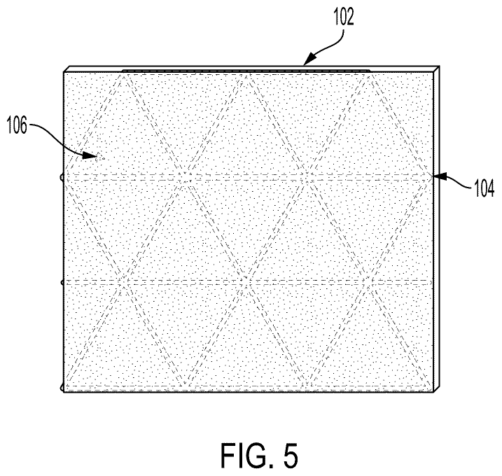

In FIG. 5 the elastic inner layer 106, now in a stretched state, is adhered to the outer layer 102 via the adhesive layer 104. In the present example, this is performed using a heat press to activate the adhesive layer 104 and bond the outer layer 102 to the inner layer 106 along the geometric pattern of the adhesive layer 104. It should be understood that other means or mechanisms of adhering, bonding, or otherwise attaching fabrics or textiles together, including but not limited to, pressure or chemical activation of adhesives, or any combination thereof can be used.

Once the elastic inner layer 106 is adhered to the outer layer 102, releasing the tension that was used put the elastic inner layer 106 in a stretched state (as seen in FIG. 5) allows the elastic inner layer 106 to return to a relaxed state (as seen in FIG. 4). The elastic inner layer 106, when in a relaxed state, causes the adhered outer layer 102 to vault/bubble up forming raised cavities 108 according to the geometric pattern of the adhesive layer 104.

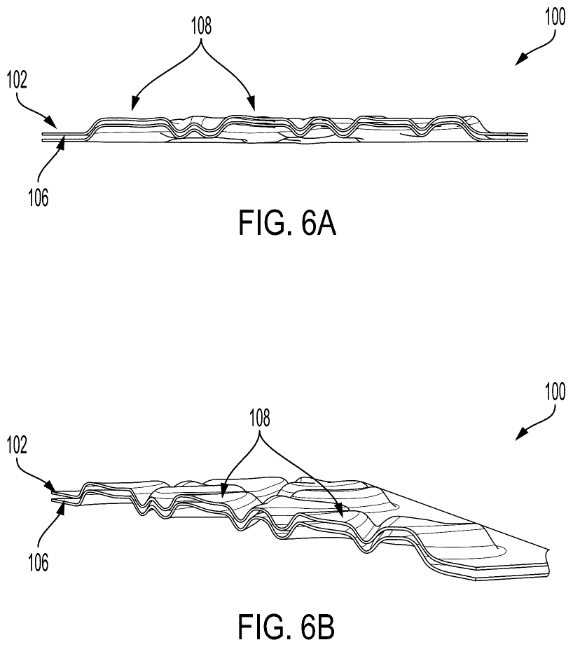

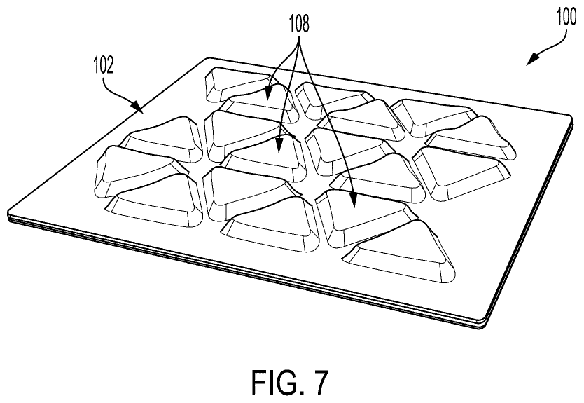

FIG. 6A and FIG. 6B shows cross-sectional views of the formation of the raised cavities 108 when the adhered outer layer 102 vaults/bubbles due to the elastic inner layer transitioning to a relaxed state. FIG. 7 shows the resulting raised cavities 108 that are formed by the vaulting/bubbling of the adhered outer layer 102 as a result of the elastic inner layer 106 being in a relaxed state. Factors including shape, size, and spacing between these cavities are determined by the geometric pattern of the adhesive. The height of the raised cavities is determined by the amount of stretch added to the elastomeric inner layer, and hence the amount of tension between the inner and outer layers. When this composite material 101 is used to construct garments, these cavities trap air between the material and the user's body. Since air is known to be a good insulator, this trapping of air provides insulation to the user. Notably, these raised cavities 108 are not required to be air-tight to provide the desired insulative properties described herein.

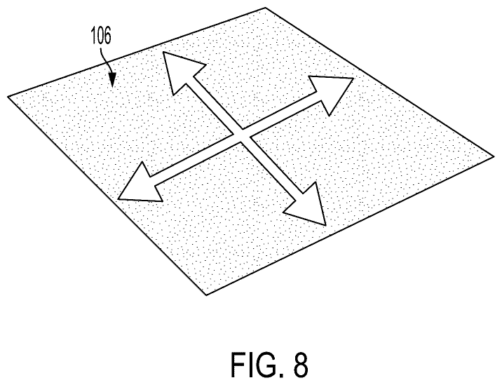

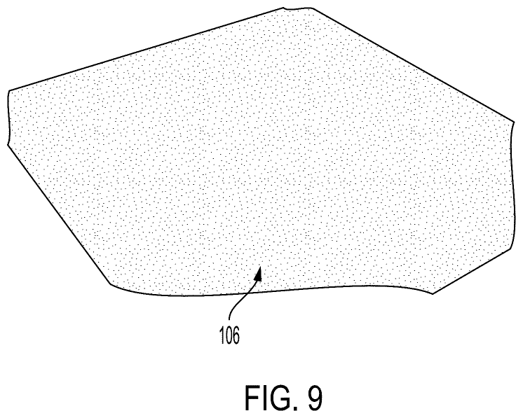

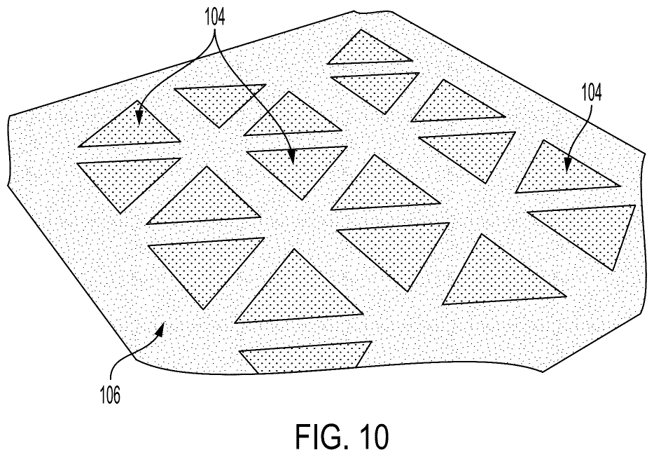

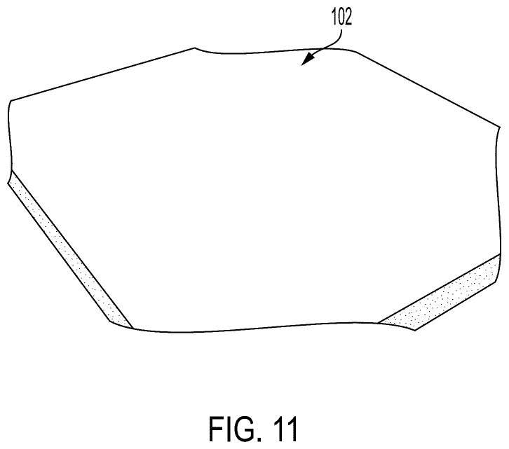

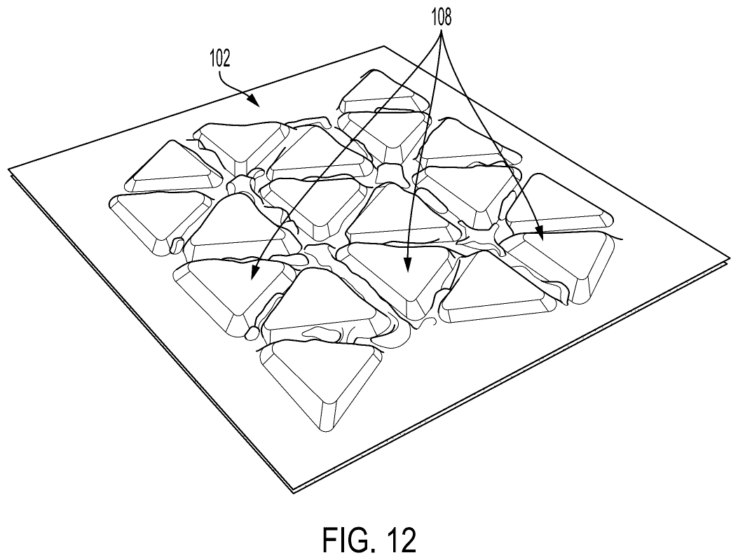

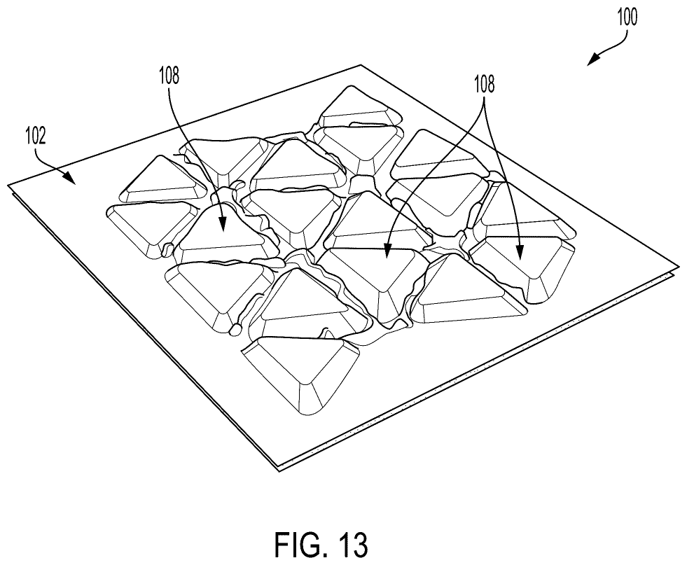

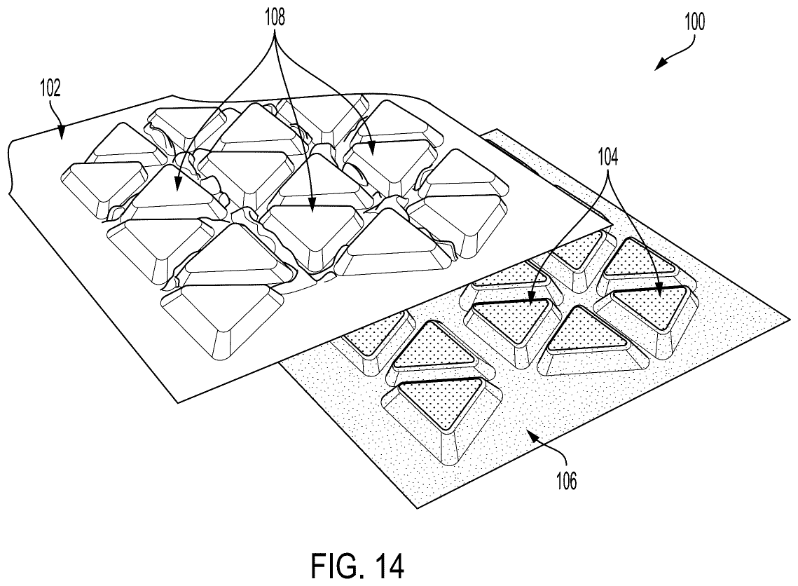

It should be understood that the order in which the layers are assembled can be reversed. An example of this can be seen in FIGS. 8-14. FIG. 8 shows a perspective view of an clastic inner layer 106 of an active insulation system in a relaxed state. FIG. 9 shows a perspective view of the elastic inner layer 106 of an active insulation system in a stretched state. FIG. 10 shows a perspective view of an adhesive layer 104 in a geometric pattern applied to the elastic inner layer 106 in the stretched state. FIG. 11 shows a perspective view of an outer layer 102 of an active insulation system applied to the adhesive layer 104. FIG. 12 shows vaulting/bubbling of the outer layer 102 forming raised cavities 108 that occur when the clastic inner layer returns to a relaxed state after being applied to the adhesive layer. Notably, the raised surface features on the outside of the outer layer 102 create a pattern in whatever arrangement corresponds to the application of the adhesive. As such, the pattern can be configured to provide additional features for a resulting garment using the fabric, such as providing acrodynamic impact on airflow passing over the fabric during use. The particular arrangement and configuration of the surface features that result on the outer layer 102 from the raised cavities 108 can be adjusted as desired for different acrodynamic impacts, as would be appreciated by those of skill in the art. FIG. 13 shows a perspective view of a formed active insulation system. FIG. 14 shows an exploded perspective view of the active insulation system 100 showing the various layers.

It should be understood that other techniques for attaching the outer layer 102 and inner layer 106 can be used such as stitching, bonding, or ultrasonic welding can be used instead of, or in addition to, an adhesive.

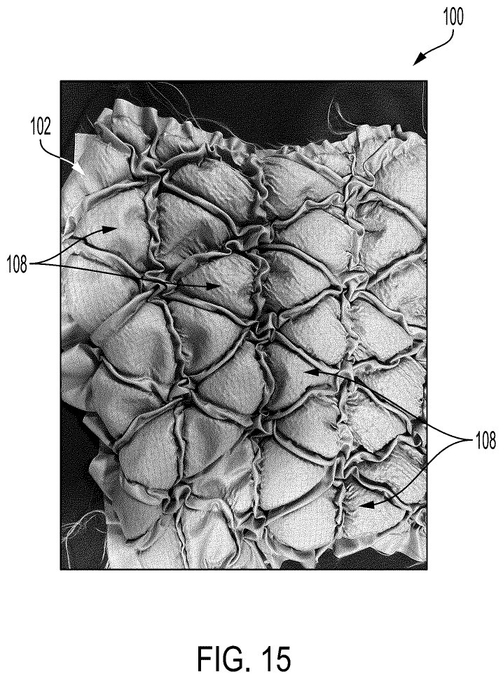

FIG. 15 shows another view of the resulting raised cavities 108 that are formed by the vaulting/bubbling of the adhered outer layer 102 as a result of the elastic inner layer 106 being in a relaxed state.

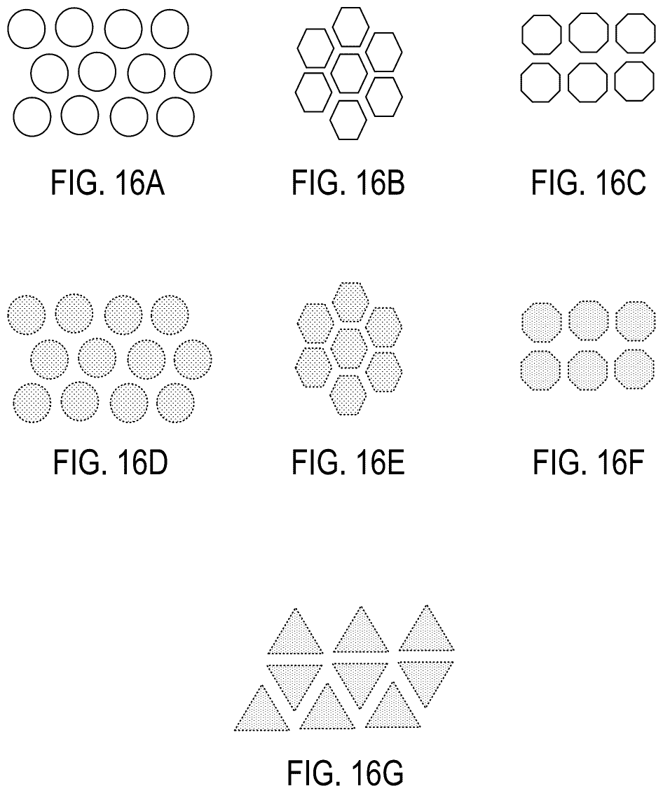

These raised cavities 108 provide air-pockets between the outer layer 102 and the wearer's body. As discussed previously, air is a tremendous insulator, thus each of the raised cavities 108 provides insulation in a manner similar to the down or fiber-filled baffles of a “puffer” jacket, but, because of the breathable nature of the elastic inner layer 106, have effectively, an open side to the raised cavity such that when ventilated are much more expeditiously cooled vs. closed fiber-filled baffles. Insulating garments commonly have zippered openings or vents that the wearer can unzip to cool themselves off if they overheat (these types of openings or vents pass completely through the entire fabric). The raised cavities 108 and the breathable nature of the elastic inner layer 106 of the composite insulating material described here allow air to flow easily between the material and the wearer, thus allowing the wearer to cool off much more rapidly when zippered opening or vent only passes through the outer layer of the fabric). The vaulting/bubbling performed by the adhered outer layer 102 and the general shape of the resulting raised cavity 108 is based on the geometric pattern of the adhesive layer 102. Here the raised cavities 108 are triangularly shaped based on the geometric pattern of the adhesive layer shown in FIGS. 3, 10, and 14. However, it should be understood that any number of geometric patterns including circles, triangles, quadrilaterals, polygons, curvilinear shapes, shapes containing both straight and curved lines, or any other shapes can be used. FIGS. 16A-16B depicts some examples of such possible patterns.

FIG. 16A depicts an adhesive layer 104 comprising a geometric pattern of circles, FIG. 16B depicts an adhesive layer 104 comprising a geometric pattern of hexagons, and FIG. 16C depicts an adhesive layer 104 comprising a geometric pattern of octagons. In some such embodiments, the geometric shapes or patterns need not be made of solid lines of adhesive. Here, FIG. 16D has a geometric pattern of circles formed by arranged dots of adhesive, FIG. 16E depicts a geometric pattern of hexagons formed of arranged dots of adhesive, FIG. 16F depicts a geometric pattern of octagons and squares formed of arranged dots of adhesive, and FIG. 16G depicts a geometric pattern of triangles formed of arranged dots of adhesive.

The fabric or textile of the adhered outer layer 102 forming the raised cavity 108 also provide slack or play in the material. That is, a garment incorporating the insulating system can stretch between the relaxed state of the inner layer 106 and the stretched state of the inner layer 106 that is adhered to the outer layer 102 via the adhesive layer 102.

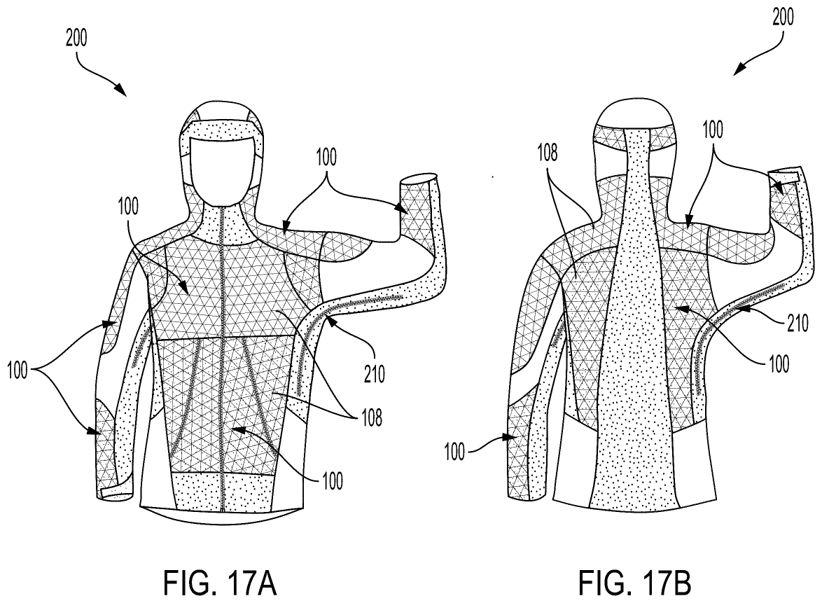

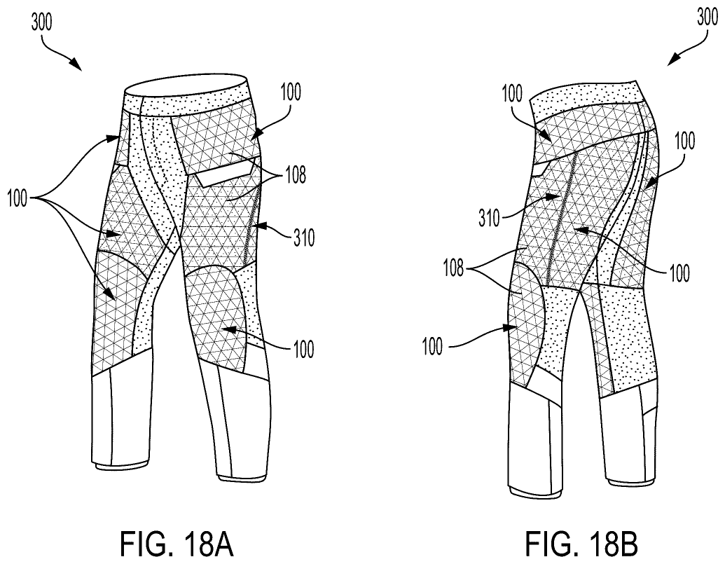

FIG. 17 and FIG. 18 depict example garments having the active insulation of the present invention. FIG. 17A depicts a front view and FIG. 17B depicts a back view of a jacket 200 incorporating the active insulation 100. FIG. 18A depicts a front view and FIG. 18B depicts a back view of pants 300 incorporating the active insulation system 100. In these examples, the jacket 200 and pants 300 incorporate insulation system 100 as described herein having an outer layer of fabric 102, an adhesive layer 104 applied to the outer layer of fabric 102 in a geometric pattern; and an elastic inner layer of fabric 106, adhered in a stretched state, to the outer layer 102 via the adhesive layer 104. The elastic inner layer 106, when in a relaxed state, causes the adhered outer layer 102 to vault/bubble into raised cavities 108 according to the geometric pattern of the adhesive 104 (depicted here as triangles).

The garments 200, 300 incorporate the active insulation system 100 in portions of the garment that require insulation but still need to be able to flex when the wearer moves such as the head, chest, stomach, back, shoulder, and arms of the jacket 200 and the waist, thighs, and knees of the pants 300. By doing so, the garment can be configured as form-fitting to a wearer of the garment when the inner layer is in the relaxed state while allowing the garment to expand in portions to the stretched state of the inner layers adhered to the outer layer via the adhesive layer to accommodate force applied by the wearer as the wearer moves thereby reducing hindrances to wearer mobility.

In certain embodiments to further enhance the temperature regulation of the garments, the garments may be provided with vents for allowing air to enter and/or leave the area between the garment and the wearer. For example, the jacket 200 may be provided with zippers 210 under each arm that can be un-zipped to more freely allow air to enter and/or leave the jacket 200. Similarly, the pants 300 can be provided with zippers 310 along each thigh that can be unzipped to more freely allow air to enter and/or leave the pants 300 and the area between the pants 300 and the wearer. The active insulation system 100 of the present invention differs from other types of insulation in that instead of trapping air in closed pockets like traditional baffles found in a puffy jacket, the air pockets provided by the raised cavity 108 detailed here are open on the inside, via the breathable nature of the elastic inner layer 106, allowing air to pass through the cell. This means that the wearer can easily cool themselves if they become too warm by simply opening zippered vents 210, 310 in the garment, allowing the warm air trapped against the body of the wearer to be flushed out and replaced by cool air from the external environment. Furthermore, in certain embodiments, the breathable nature of the elastic inner layer 106 allows for the vents 210, 310 to be disposed only in the outer layer 104 and not the inner layer 106 of the system 100 while still providing temperature regulation. That is, the vents 210, 310, can be configured to create an opening only in the outer layer 104 and not the inner layer 106; or alternatively as is conventionally known, the vents 210, 310, can be configured to create an opening through both the outer layer 104 and the inner layer 106. The ventilation provided by the insulation described in this invention makes this invention more adaptable to changing environmental conditions than other insulated garments on the market today.

Also as mentioned earlier, puffy garments typically use a down-proof fabric that is tightly woven and often has a DWR finish on it. This fabric does not wick sweat from the user's body and can cause sweat to build up. This buildup of sweat can be problematic for the user. Insulating garments made of fleece typically use a wicking fabric, which helps the user stay dry, but are not wind or waterproof. The present invention makes use of a stretch material as an inside layer. This material can be selected to be wicking to help sweat escape, including through the border areas between the adhesive layers.

The composite material 101 of the present invention is unique in that it provides insulation without the use of a fill material such as down or polyfill, nor the requirement for airtight inflatable baffles. This material is also unique in that there is a wide range of different face fabrics that can be used, with no strict requirements such as downproofness. This material is also unique in that, when it is used to make garments, it traps air with only a single layer of composite material 101 by using the raised cavities to trap air between the outer layer of the fabric and the user's body.

The insulation provided by this garment is provided by air rather than a fill material, such as down or a synthetic fill. Down insulation requires the use of downproof fabrics to prevent the keep down or feathers from leaking through the fabric and escaping. Similarly, synthetic insulations require the use of a smooth faced fabric, as a fabric with a rough finish can cause the synthetic insulation to break apart and degrade over time. As such, both down and synthetic insulation typically use a tightly woven and calendared face fabric that has limited breathability. Since the composite material 101 described here provides insulation without any fill material, there are no restrictions on what sort of face fabrics can be used. This allows for more breathable fabrics than would otherwise be possible.

There are other garments on the market use air as an insulator through inflatable sections of the jacket. These inflatable sections are completely air-tight, and therefore have limited breathability. Because the composite material 101 makes use of a weatherproof outer layer and a breathable elastic inner layer, the raised cavities trap air between the outer layer and the wearer's body while still allowing air to circulate in and out of the raised cavity via the breathable elastic inner layer. This breathability provided by the inner layer is a huge advantage over inflatable garments, and allows garments made of this fabric to be work in high-cardiovascular-output activities where breathability is essential.

The stretch of the presented composite material 101 allows for a form-fitting garment that accommodates force applied by the wearer as the wearer moves. This is an advantage over other types of insulation. Down-proof face fabrics that are typically used for other insulated garments are typically made of a tightly woven nylon fabric that has zero stretch or limited stretch, which can limit the mobility of the athlete.

As utilized herein, the terms “comprises” and “comprising” are intended to be construed as being inclusive, not exclusive. As utilized herein, the terms “exemplary,” “example”, and “illustrative”, are intended to mean “serving as an example, instance, or illustration” and should not be construed as indicating, or not indicating, a preferred or advantageous configuration relative to other configurations. As utilized herein, the terms “about,” “generally”, and “approximately” are intended to cover variations that may existing in the upper and lower limits of the ranges of subjective or objective values, such as variations in properties, parameters, sizes, and dimensions. In one non-limiting example, the terms “about,” “generally”, and “approximately” mean at, or plus 10 percent or less, or minus 10 percent or less. In one non-limiting example, the terms “about,” “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. An insulating composite material comprising:
an outer layer of fabric/textile;
an adhesive layer applied to the outer layer of fabric in a geometric pattern; and
an elastic inner layer of fabric/textile, adhered in a stretched state, to the outer layer via the adhesive layer;
wherein the elastic inner layer, when in a relaxed state, causes the adhered outer layer to vault/bubble forming raised cavities according to the geometric pattern of the adhesive layer; and
wherein the insulating composite material can stretch between the relaxed state of the inner layer and the stretched state of the inner layer that is adhered to the outer layer via the adhesive layer.

2. The insulating composite material of claim 1, wherein the outer layer of fabric/textile comprises a water repellent, vapor permeable fabric/textile.

3. The insulating composite material of claim 1, wherein the geometric pattern comprises one or more of circles, triangles, quadrilaterals, polygons, curvilinear shapes, or shapes containing both straight and curved lines.

4. The insulating composite material of claim 1, wherein the geometric pattern is laser cut or masked from an adhesive sheet.

5. The active insulation of claim 1, wherein the adhesive is extruded or printed in the geometric pattern.

6. The insulating composite material of claim 1, wherein the adhesive layer comprises adhesive dots or other smaller shapes arranged in a geometric pattern.

7. The insulating composite material, wherein the elastic inner layer of fabric/textile comprises a moisture-wicking stretch fabric/textile.

8. The insulating composite material, wherein the stretched state of the elastic inner layer of fabric/textile is stretched in 2 dimensions.

9. The insulating composite material, wherein the stretched state of the elastic inner layer of fabric/textile is stretched in 4 dimensions.

10. A garment formed of a composite material having active insulation, the garment comprising:
an outer layer of fabric;
an adhesive layer applied to the outer layer of fabric in a geometric pattern; and
an elastic inner layer of fabric, adhered in a stretched state, to the outer layer via the adhesive layer;
wherein the elastic inner layer, when in a relaxed state, causes the adhered outer layer to vault/bubble forming raised cavities according to the geometric pattern of the adhesive;
wherein the garment is sized and configured as form-fitting to a wearer of the garment when the inner layer is in the relaxed state and the garment expands in portions to the stretched state of the inner layers adhered to the outer layer via the adhesive layer to accommodate force applied by the wearer as the wearer moves thereby reducing hindrance on wearer mobility.

11. The garment of claim 10, wherein the outer layer of fabric/textile comprises a water repellent, vapor permeable fabric/textile.

12. The garment of claim 10, where the garment further comprises vents.

13. The garment of claim 12, where the vents comprise zippers.

14. The garment of claim 10, wherein the geometric pattern comprises one or more of circles, triangles, quadrilaterals, polygons, curvilinear shapes, or shapes containing both straight and curved lines.

15. The garment of claim 10, where in the geometric pattern is laser cut from an adhesive sheet.

16. The garment of claim 10, the adhesive layer comprises adhesive dots or other smaller shapes arranged in a geometric pattern.

17. The garment of claim 10, wherein the elastic inner layer of fabric/textile comprises a moisture wicking stretch fabric/textile.

18. The garment of claim 10, wherein the stretched state of the elastic inner layer of fabric/textile is stretched in 2 dimensions.

19. The garment of claim 10, wherein the stretched state of the elastic inner layer of fabric/textile is stretched in 4 dimensions.

20. An active insulation system for a garment, the system comprising:
an outer layer of fabric/textile;
an adhesive layer applied to the outer layer of fabric in a geometric pattern; and
an elastic inner layer of fabric/textile, adhered in a stretched state, to the outer layer via the adhesive layer;
wherein the elastic inner layer, when in a relaxed state, causes the adhered outer layer to vault/bubble forming raised cavities according to the geometric pattern of the adhesive layer; and
wherein a garment incorporating the insulating composite material can stretch between the relaxed state of the inner layer and the stretched state of the inner layers that is adhered to the outer layer via the adhesive layer.

21. A method of manufacturing an insulating composite material comprising:
providing an outer layer of fabric/textile;
applying an adhesive layer to the outer layer of fabric in a geometric pattern; and
providing an elastic inner layer of fabric/textile;
applying tension to the elastic inner layer of fabric/textile to stretch the elastic inner layer to a stretched state;
adhering the elastic inner layer of fabric/textile in the stretched state to the outer layer via the adhesive layer; and
releasing tension used to stretch the elastic inner layer in stretched state,
wherein the elastic inner layer, when in a relaxed state, causes the adhered outer layer to vault/bubble forming raised cavities according to the geometric pattern of the adhesive layer.

22. A method of manufacturing insulating composite material comprising:
providing an elastic inner layer of fabric/textile;
applying tension to the elastic inner layer of fabric/textile to stretch the elastic inner layer to a stretched state;
applying an adhesive layer in a geometric pattern to the elastic inner layer of fabric in the stretched state;
providing an outer layer of fabric/textile;
adhering the outer layer of fabric/textile to the elastic inner layer of fabric/textile in the stretched state via the adhesive layer; and
releasing tension used to stretch the elastic inner layer in stretched state,
wherein the elastic inner layer, when in a relaxed state, causes the adhered outer layer to vault/bubble forming raised cavities according to the geometric pattern of the adhesive layer.
